(19) United States
(12) Patent Application Publication
(10) Pub. No.: US 2003/0078880 A1
(43) Pub. Date: Apr. 24, 2003

(54) Method and system for electronically signing and processing digital documents

(76) Inventors: Nancy Alley, Tucson, AZ (US); Jonathan Kearns, Oro Valley, AZ (US); Kelly Purcell, Phoenix, AZ (US)

Correspondence Address: BAKER & BOTTS, 30 ROCKEFELLER PLAZA, NEW YORK, NY, 10112

(21) Appl. No.: 10/299,511

(22) Filed: Nov. 19, 2002

Related U.S. Application Data
(63) Continuation-in-part of application No. 09/415,893, filed on Oct. 8, 1999, now abandoned.

(51) Int. Cl. G06F 17/60

(52) U.S. Cl. 705/38

(57) ABSTRACT

A method and system for managing the electronic signing of digital documents is disclosed. An electronic document created and prepared for signing by associating certain signing constraints with the document. Indicia of the signing constraints are encoded into a document information block or blocks that are embedded into the document. The information block may include indicia of a database record at a central server that stores indicia of the signing constraints in addition to or in lieu of including the signing constraint indicia in the document information block or blocks. Upon receiving the prepared document at a signing terminal, the information blocks are extracted and the signing constraints tested. If the user desires to sign the document, and if the user is permitted to sign, the document is electronically signed and transmitted to the central file server for storage.

### RELATED APPLICATIONS

This application is a continuation-in-part of U.S. patent application Ser. No. 09/415,893, filed on Oct. 8, 1999, entitled “Computer System For Loan Processing,” which will become abandoned upon the granting of a filing date to the instant application and is incorporated herein by reference in its entirety.

### BACKGROUND OF INVENTION

The present invention relates, in general, to electronic documents, and more particularly, to the electronic signing and processing of digital documents.

Electronic or digital signatures on digital documents have taken on an increasingly important role in commerce, especially e-commerce. Electronically signed documents provide advantages over traditional paper documents that require ink signatures. For instance, the signing of paper documents requires the interaction of both parties to sign, store, copy and mail documents. There is the opportunity for some of the documents to be lost in transit such as mailing or by couriers. Security of the information can also be a concern if the documents are delivered to an incorrect address or if they are left in places that can be observed by unauthorized individuals.

Electronic or digital signatures offer the ability to form binding written contracts using completely digital documents. The documents may be prepared and transmitted to a party for signing almost instantaneously over a computer network, such as the Internet. The document may be transmitted in encrypted form so that only the designated recipient may review the document. The document may be reviewed by the signing party, and a digital signature of the signing party may be affixed thereto. The enforceability of documents signed with electronic signatures in the United States is regulated by individual state laws, some of which follow the Uniform Electronic Transactions Act (“UETA”) as well as by the federal E-SIGN law when the document involves a transaction in or affecting interstate commerce. The E-SIGN law is codified at 15 U.S.C. §§7001-7006, 7021, 7031.

A digital signature is a transformation of an electronic document by one person using a private key in connection with a public key cryptography algorithm so that a person having the transformed message and the corresponding public key can accurately determine: (i) whether the transformation was created using the private key that corresponds to the signer's public key; and (b) whether the message has been altered since the transformation was made.

Specifically, digital signature techniques typically make use of asymmetric encryption algorithms using a private digital key and a public digital key, in connection with a one-way algorithm, often called a hashing or digesting algorithm. In these systems, the public key is data available in the public domain. The private key is sensitive data personal to its owner. In one embodiment, the private key may be stored in a computer associated with the user, such as a document signing terminal described herein. The private key may be accessible only by entering a secret password, pass phrase, or personal identification number (PIN) associated with the user. In an alternative embodiment, the private key is maintained on a secure media, such as a smart card. In this embodiment, any encryption or signing algorithm that requires the use of the private key may be carried out entirely within the secure media, such as in a processor on the smart card. Examples of smart card systems are described in U.S. Pat. No. 5,659,616 issued to Sudia on Jul. 16, 1997 and U.S. Pat. No. 5,748,738 to Bisbee et al. on May 5, 1998 which are hereby incorporated by reference in their entireties. In a further embodiment, any encryption or signing algorithm that requires the use of the private key may be carried out entirely within a secure computing environment associated with the signing terminal. Such secure computing environments are disclosed, for example, in U.S. Pat. No. 6,092,202, entitled “Method and System For Secure Transactions In A Computer System” to Leonard Veil, Gary Ward, Richard Alan and Eric Alan, issued on Jul. 18, 2000, incorporated herein by reference in its entirety, or U.S. Pat. No. 6,138,239, entitled “Method and System For Authenticating And Utilizing Secure Resources In A Computer System,” to Leonard Veil, issued on Oct. 24, 2000, also incorporated herein by reference in its entirety.

In order to digitally sign an electronic document, typically the user will “hash” or “digest” the document to be signed, using a one-way algorithm. Numerous such one-way algorithms are well known to one of ordinary skill in the art. The resultant “hash” corresponds to the content of the document, but the text of the document may not be recovered from the hash. This user then indicates his acceptance of the document by encrypting the hash using his or her private key. The signed hash may then be transmitted either together with or without the original document to a recipient. The signed hash functions as a signature because a recipient of the signed document may perform the identical hash on the unsigned document to generate a reference hash, decrypt the received encrypted hash, using the public key associated with the user, and compare the decrypted hash to the reference hash. If the two hashes are identical, the recipient has verified that the signer was in possession of the original document, since any alteration of the document before hashing by the signer would have produced a different hash. The recipient has also verified that the signer has manifested an intent to accept the document, since only the signer could have encrypted the hash using the signer's private key.

Digital signature systems typically make use of digital certificates to facilitate the exchange of and verify the authenticity of public keys. Specifically, a digital certificate binds the public key to a name, thus providing a digital identity. The digital certificate is used to verify that the public key belongs to the particular entity signing a document using the associated private key. FIG. 8 is a diagram of a conventional prior art certificate structure. The conventional certificate structure conforms, for example, with the X509 v.3 certificate structure. A conventional digital certificate, as shown in FIG. 8, includes a user name 502, a certificate validity date 504, and a public key 508. The certificate is “signed” by a mutually trusted authority (i.e., trusted by the certificate holder and the party with whom he or she is communicating). The mutually trusted authority, commonly known as the certificate authority or issuing authority 506, authenticates the user identity by providing a signature 510, representing an assertion by the certificate authority that the public key 508 (and the mathematically related private key) belong to the user 502. User name 502 may be a full name of the user, a unique identifier of the user, such as an email address, or other indicia of identification.

FIG. 9 is a diagram of a certificate chain for authenticating digital certificates. A certificate chain having a root certification authority 522 allows individuals with different certificate authorities to electronically communicate with each other. The root certification authority 522 allows different certification authorities to issue digital identities to individuals. The certificate chain creates a trust relationship where trust flows upwards from each transaction party to the root certification authority 522.

For example, there may be a Japanese certification authority 528, a French certification authority 526, and a U.S. certification authority 524, each issuing digital identities to Japanese, French and U.S. residents, respectively. In Japan, a Tokyo region certification authority 538 may issue a digital identity 546 to J. Yen. In France, a Paris region certification authority 536 may issue a digital identity 544 to F. Frank. In the U.S., there may be an East certification authority 534, a Mid-west certification authority 532 and a West certification authority 530. The West certification authority 530 may issue a digital identity to a California certification authority 540 which, in turn, may issue a digital identity 542 to A. Doe.

When A. Doe, a California resident, wants to communicate with J. Yen in Japan and/or with F. Frank in France, A. Doe needs to be sure that the electronic communications are conducted with J. Yen and/or F. Frank and not with imposters. Through existing certificate technology, it is possible to verify the digital identity of a sender of transaction messages by traversing upwards through the certificate chain. In checking the digital certificate in someone's message, A. Doe can check if there is a valid digital identity in the person's digital certificate. That is, A. Doe can check if in J. Yen's message there are valid certification authority signatures of the Tokyo region certification authority 538, the Japan certification authority 528, and the root certification authority 522.

The certification authority may also maintain a list of invalid or revoked certificates. This would be of use where a user's private key has been lost or otherwise compromised. In that situation, the certification authority could revoke the certificate associated with that private/public key pair before the certificate was originally to expire. In that fashion, persons receiving documents that purported to be signed by a private key associated with a particular certificate could check a certificate revocation list maintained by the certification authority to determine whether the certificate is still valid.

While current electronic signatures and encryption technology make it possible to securely exchange and sign electronic documents, these systems do not provide a standard way to store such documents after they are signed. Additionally, current systems do not permit a party that is preparing a document for subsequent signature to specify conditions that must exist before a party may sign the document.

### SUMMARY OF THE INVENTION

In various aspects, the present invention involves a method and system for managing the electronic signing and storage of digital documents.

In one exemplary embodiment, a method is provided for signing a digital document. The method involves embedding in the digital document an information block associated with a signing constraint. The modified document is transmitted over a computer network to a document signing terminal. After reviewing the document, a user at the document signing terminal indicates a request to apply his or her electronic signature to the document. The document signing terminal determines whether the user is permitted to sign the document based on the signing constraint associated with the information block embedded in the document. If the determination reveals that the user is permitted to sign the document, the document is electronically signed using the user's private signature key and the signed document is transmitted to a central digital file server.

In another exemplary embodiment, a system is provided for signing a digital document. The system includes a computer readable storage area containing computer code for actuating a processor of a document preparation terminal. The code provides functionality for accessing a digital data file and for embedding in the digital data file at least one information block associated with a signing constraint. The system also includes an electronic document file storage device having a network interface for receiving digital data files and further includes a digital storage medium for storing the digital data files received by the network interface device. The system further includes a second computer readable storage area containing further computer code for actuating a processor of a document signing terminal. The further computer code provides functionality to the signing terminal for (a) receiving a request from a user of the terminal to electronically sign the digital data file with the information block associated with a signing constraint embedded therein, (b) determining whether the user of the document signing terminal is permitted to sign the digital data file based on the signing constraint associated with the information block embedded in the document, (c) electronically signing the digital data file with the user's private signature key if the determination reveals that the user is authorized to sign the document, and (d) transmitting the signed document to the electronic file storage device.

In yet another exemplary embodiment, a method is provided for signing a digital document. The method involves embedding in the digital document an information block identifying a database record in a central database. The modified document is transmitted over a computer network to a document signing terminal. After reviewing the document, a user at the document signing terminal indicates a request to apply his or her electronic signature to the document. A record lookup request, the contents of which include or are otherwise derived from information in the at least one information block, is transmitted by the document signing terminal to the central database. A response to the lookup request that includes indicia associated with one or more signing constraints is sent to the document signing terminal, where it is determined whether the user of the signing terminal is permitted to sign the document based on the signing constraint. If the constraint is satisfied, the document is electronically signed using the user's private signature key and the signed document is transmitted to the central file server.

In yet another exemplary embodiment, a system is provided for signing a digital document. The system includes a central database and a computer readable storage area containing computer code for actuating a processor of a document preparation terminal. The code provides functionality for accessing a digital data file and for embedding in the digital data file at least one information block identifying a database record in a central database. The system also includes an electronic document file storage device having a network interface for receiving digital data files as well as a digital storage medium for storing the digital data files received by the network interface device. The system further includes a second computer readable storage area containing further computer code for actuating a processor of a document signing terminal. The further computer code provides functionality to the signing terminal for (a) receiving a request from a user of the terminal to electronically sign the digital data file with the information block associated with a signing constraint embedded therein, (b) transmitting to the central database a record lookup request, the contents of which include or are derived from the information block, (c) receiving from the central database indicia associated with at least one signing constraint in response to the record lookup request, (d) determining whether the user of the document signing terminal is permitted to sign the digital data filed based on the signing constraint, (e) electronically signing the digital data file with the user's private signature key if the determination reveals that the signing constraint is satisfied, and (f) transmitting the signed document to the electronic file storage device.

In a still further exemplary embodiment of the present invention, a method is provided for electronically signing a digital document. The method includes embedding in the digital document, at a document preparation terminal, a document information block identifying one or more database records stored in a central database accessible by a central server. The document with the embedded information block is transmitted over a computer network, such as the Internet, to a document signing terminal. The signing terminal may receive a request from a user at the terminal to electronically sign the document. The signing request includes a user identification block identifying the user, such as a user ID. A signing permission request is transmitted by the signing terminal to the central server, the contents of the signing permission request include at least information from or derived from the document information block as well as the user identification information block. The central server then accesses the central database to retrieve one or more database records identified by the document information block in order to retrieve indicia of a signing constraint. The central server then determines, based on the signing constraint as well as the user identification information block, whether the user is permitted to sign the document. A response is then received from the central server by the document signing terminal indicating whether the user is permitted to sign the document. If the user is permitted to sign, the signing terminal electronically signs the document using the user's private signature key and the signed document is transmitted to the central file server for storage.

### BRIEF DESCRIPTION OF THE DRAWINGS

For a more complete understanding of the present invention, reference is made to the following detailed description of the exemplary embodiments with reference to the accompanying drawings in which:

FIG. 1 is a schematic diagram of an exemplary system for carrying out the present invention;

FIG. 2 illustrates a flow diagram of an exemplary method in accordance with the present invention;

FIGS. 3-5 illustrate user interfaces that may be presented to a user of a portion of a system in accordance with the present invention;

FIG. 6 illustrates an exemplary data structure for use in one embodiment of the present invention;

FIG. 7 illustrates an exemplary data structure for use in one embodiment of the present invention;

FIG. 8 illustrates a prior art data structure for a digital certificate useful in an embodiment of the present invention;

FIG. 9 illustrates an exemplary digital certificate authorization chain useful to understand the operation of one embodiment of the present invention; and

FIG. 10 illustrates a user interface that may be presented to a user of a potion of a system in accordance with the present invention to manage electronic documents.

### DETAILED DESCRIPTION OF THE EXEMPLARY EMBODIMENTS

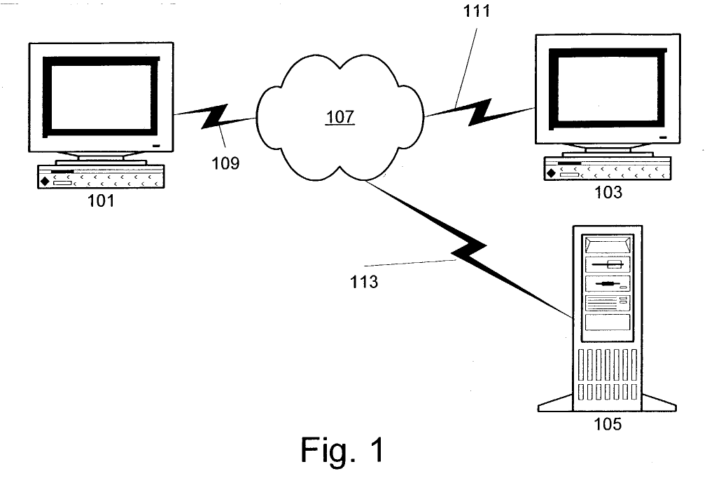

In FIG. 1 is illustrated an exemplary system for implementing the teachings of the present invention. The system includes a document preparation terminal 103, a document signing terminal 101, a central digital file server 105, and a computer network 107. The document preparation terminal 103 and document signing terminal 101 may be any computing device capable of carrying out the functions of the present invention. In one exemplary embodiment, the terminals 101 and 103 are personal computers employing programmable general purpose processors, such as a Pentium™ processors from Intel™. Alternatively, terminals 101 and 103 may be portable computing devices, such as personal digital assistants (PDAs) or mobile telephones having a microprocessor for implementing the present invention. The document signing terminal 101 may also include a secure computer environment, as previously described, to carry out secure computer tasks. There is no need that terminals 101 and 103 be similar or identical to each other as long as they are capable of operating in accordance with the teachings of the present invention. Both terminals 101 and 103 include a network interface device (not shown), which couples the terminals to computer network 107. The network interface device may be, for example, an Ethernet card, modem or other device allowing digital communications over a communications network. In the exemplary embodiment, the network 107 is the Internet, but other proprietary and public computer networks could be used in addition to, or in lieu of the Internet. The coupling of terminals 101 and 103 to computer network 107 is represented by two-way communication channel indicators 109 and 111, respectively. Further details of the operation of document preparation terminal 103 and document signing terminal 101 will be discussed herein.

Central digital file server 105 includes hardware for storing digital data files. The hardware may include hard disk drives, volatile semiconductor memory, nonvolatile semiconductor memory, tape storage media, and other well-known storage media. File server 105 also includes a controller, not shown, for managing file storage and retrieval. The controller of the file server may be a programmable general purpose processor or may be specific hardware for controlling file server activities. File server 105 also includes a network interface device (not shown) for coupling the server to computer network 107 through communication channel 113. File server 105 may include functionality in addition to storing and retrieving files, as will be discussed in further detail herein.

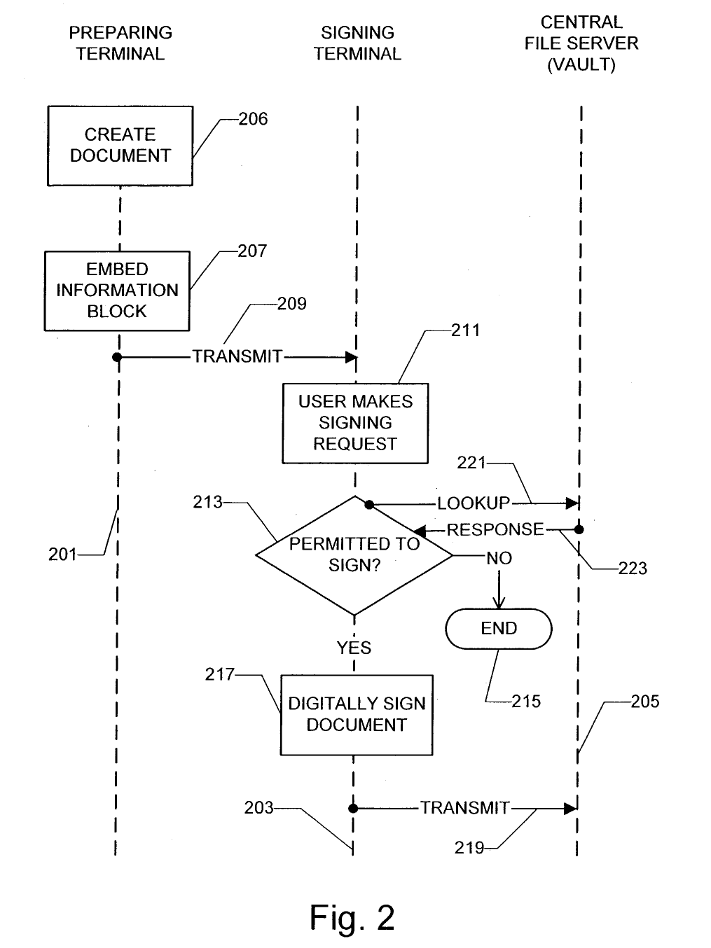

Reference will now be made to FIG. 2 where a flow diagram of the operation of one exemplary embodiment of the present invention is illustrated. The activities of three separate devices are depicted, specifically, a document preparation terminal 201, a document signing terminal 203 and a central file server, occasionally referred to herein as a document vault, 205. The process begins at the top of FIG. 2 with the creation of an electronic document 206. The document creation process may include any of a number of well known processes, such as typing and/or formatting a document using word processor software, scanning into digital form a paper document, or use of proprietary document creation techniques. In the exemplary embodiment, the electronic document is in the portable document format (“PDF”) and the documents may be created using ADOBE ACROBAT™ or similar software. Although document creation step 206 is shown occurring at the document preparation terminal 201, the document creation step 206 may occur at another location as long as the electronic document is made available to the document preparation terminal 201 before the subsequent steps are performed.

Once a document is created and made available at the document preparation terminal 201, an information block is embedded in the document during step 207. An information block, also referred to herein as a document information block, is computer readable data that may be subsequently extracted from the document as discussed in further detail herein. In one exemplary embodiment, the document information block is associated with a signing constraint that determines the condition or conditions that must be satisfied before the document can be electronically signed by a recipient.

For example, the document information block may indicate an expiration date, before which the document must be signed. Accordingly, a user would not be permitted to electronically sign the document after that date. This would be useful, for example, when the party preparing the document wishes to control the number of unsigned documents circulating among potential signers or where a document reflects a contractual offer that must be accepted (as indicated by signing) within a certain period of time.

In another exemplary embodiment, the document information block may indicate an authorization level requirement. This type of requirement may be useful when various levels of digital certificates are issued by a certification authority. For example, a certification authority, such as the California certification authority 540 shown in FIG. 9, may issue a level one certificate when the user has provided a first level of information to prove his or her identity. The certification authority 540 may issue, for example, a level two certificate when the user has provided more thorough information to prove his or her identity or after a thorough background check is performed by the certification authority to verify the identity of the user. Thus, the party preparing the document for signing may require that the party signing the document have a level two certificate before he or she is permitted to sign the document by indicating a particular certification level requirement in the document information block. This would be advantageous, for example, when the document relates to a transaction having a relatively large pecuniary value or where the transaction necessitates a relatively higher level of confidence in authenticity of the purported identity of the signing individual.

In another exemplary embodiment, the document information block may indicate one or more certification authorities that are accepted by the party preparing the document. The signer would thus not be allowed to sign the document unless he or she had a digital certificate issued by a certification authority indicated by the document information block.

In another exemplary embodiment, a document information block might indicate a signing constraint that the signer must consent to the use of electronic records. The legality or enforceability of certain electronic documents under the E-SIGN law depends on the signer consenting to the use of electronic documents rather than paper documents. Accordingly, a document information block may indicate that the signer must consent to the use of electronic documents in the transaction before he or she is permitted to sign the document. Alternatively, the signing user may be required to consent to the use of electronic documents before he or she is permitted to download the signing software application.

A further type of signing constraint that could be associated with a document information block is an indication that the signer must agree to treat the signed document as a transferable record. Under the E-SIGN law, a transferable record is a document that, among other requirements, would be a note under Article 3 of the Uniform Commercial Code if the record were in writing. For a electronic transferable record to have effect, the signer must expressly agree that the record is to be treated as transferable. Accordingly, a document information block may indicate that the signer must expressly consent to treat the signed document as a transferable record before he or she is permitted to sign the document.

In a further exemplary embodiment, a document information block may indicate a particular software type or version that the signer must have in operation at the signing terminal. If the user has an improper type of signing software or older version of the signing software than is indicated by the document information block, the user will not be permitted to sign the document. The user may be provided with instructions detailing how to retrieve the proper software version if the signing constraint is not satisfied. This embodiment of the document information block may be useful where different forms of signing software are provided to different signing terminals or where the signing terminal software is revised over time, such as to improve security or add functionality.

In yet another exemplary embodiment of the present invention, a document information block identifies the person or persons who are allowed to sign the document. Exemplary forms of document information blocks in accordance with this embodiment include: a wildcard, indicating that any user can sign; an identifier associated with a particular user, such as a user id that uniquely identifies the user that is allowed to sign; a particular first and last name of a person allowed to sign; a company name, indicating that any person who is employed by the identified company may sign; and an authorized company signer indicator, indicating that any user authorized to sign on behalf of the identified company, such as an officer, may sign.

In a still further embodiment, a document information block may indicate that the signal terminal must have a particular hardware capability, such as a secure computing environment, as previously described. If the signing terminal does not have the necessary hardware capability, the user will not be permitted to sign the document. Further, the user may be prohibited from viewing the document in this embodiment. Such a restriction may be advantageous when the document is particularly sensitive and the party preparing the document does not wish to allow the signing party to make copies or otherwise distribute the document. In this case, the document may be transmitted in an encrypted form and the signing software may not permit the user to decrypt and view the document except by use of a secure computing environment.

Whatever the nature of the document information block or blocks that are generated, step 207 involves embedding this information block into the digital document file. In one exemplary embodiment, the information block or blocks are encoded, such as into an XML data block, and inserted into a hidden form field inside the PDF document using commercially available software known as ACTIVE PDF.

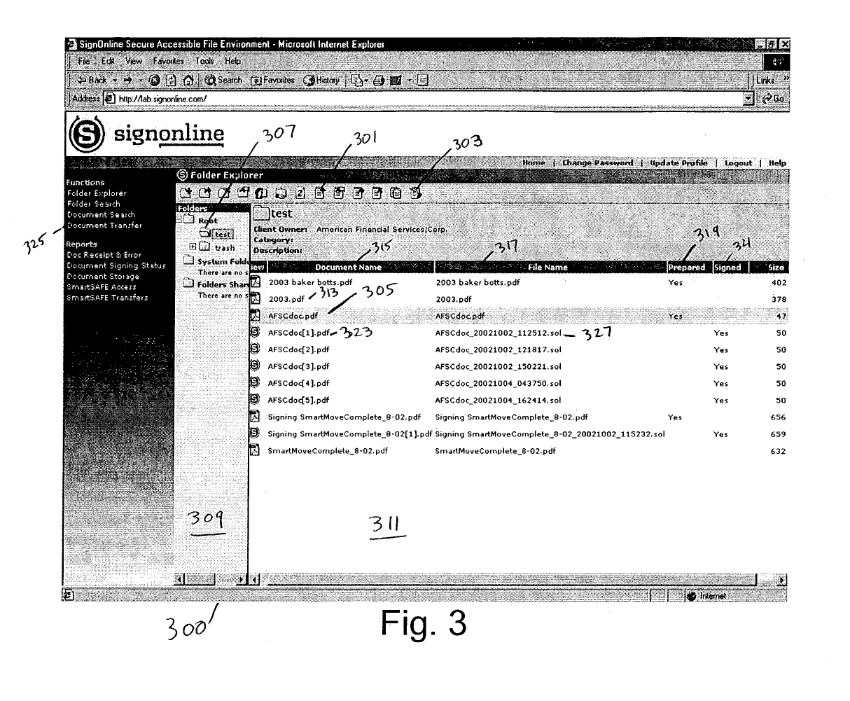

Referring now to FIG. 3, a user interface presented to a user at a document preparation terminal in an exemplary embodiment of the present invention is illustrated. The user interface may be presented through a web browser application window 300. In the depicted embodiment, browser is INTERNET EXPLORER™ from MICROSOFT™. A user at a document signing terminal wishing to prepare a document for signing could direct his or her web browser to the address of a website providing functionality for document preparation in accordance with the present invention.

At various instances throughout this description, references will be made to a central file server, central database and central server. While these devices may be discrete systems and, for clarity, are generally discussed as though they are discrete systems throughout this description, it should be understood that the functionality of each of these devices could be combined into a single computer with associated suitably programmed processor, memory and storage. When these various functions are performed by a single computer, the computer is referred to as an electronic document vault, or simply, vault. Consequently, the computer that provides functionality for document preparation may also be the vault.

After authentication, such as by entering a User ID and password, the user might then be presented with a list of files, such as the file list shown in frame 311. In the illustrated embodiment, files are organized into folders, such as the folder named “test” 307. Within the “test” folder 307 are shown data records representing various electronic documents, such as records 313 and 305. Each data record includes information about an electronic document, such as the document name, as shown in column 315, file name, as shown in column 317, and an indication of whether the document has been prepared by inserting an information block or blocks, as shown in column 319. In the embodiment illustrated, the website hosting the document preparation application also allows access to a central file server or vault where signed documents are stored after the signing process is complete, discussed further in detail herein. Consequently, records 305 and 313 also include an indication of whether the document has been signed, as shown in column 321.

A user may select a previously stored document for preparation, such as by clicking on one of the record entries, 305 and 313, using a user input device, such as a computer mouse, not shown. Upon selection, the data record will appear highlighted, such as is shown for record 305. After selecting a document to prepare, the user may select a preparation icon, such as icon 303. If the document the user wishes to prepare does not appear in frame 311, the user may select an add document icon, such as icon 301. Upon selecting icon 301, the user is prompted for the file name and location of an electronic document. The document preparation application may then upload the document to the central file server over a computer network using the specified name and file location, and create a new record entry in frame 311, corresponding to the document. Alternatively, the document preparation application may create a new entry in frame 311 without uploading the document, such as by associating therewith a link to or address of the specified document.

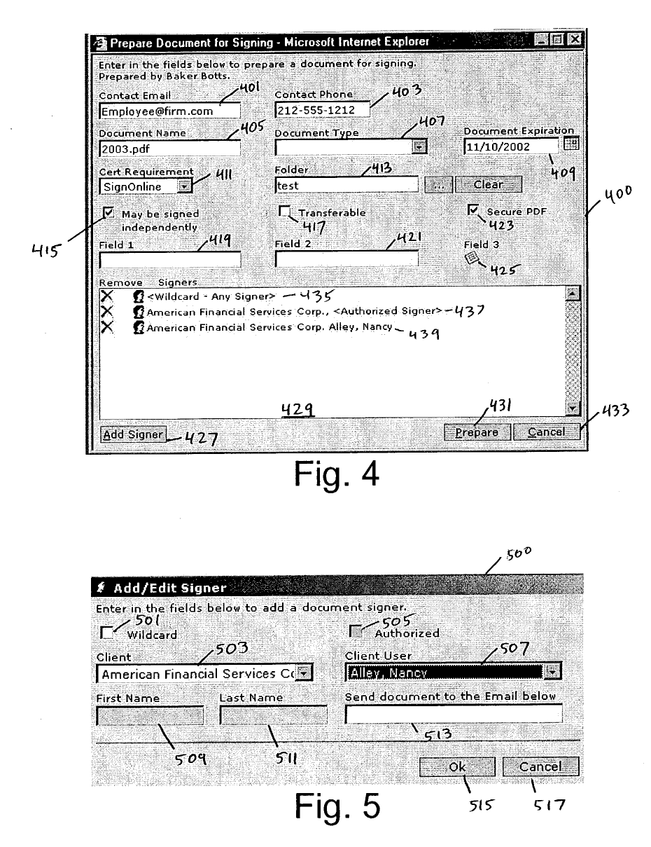

Once a document has been selected and the prepare document icon is actuated, the user is prompted to enter information that may be encoded and embedded in the prepared document. In the exemplary embodiment, a user interface in the form illustrated in FIG. 4 is presented to the user to prompt the user for information. As indicated the user at the document preparation terminal is prompted to enter: a contact email address 401 and phone number 403 of the user preparing the document; a document name 405 that will be used to identify the document after its preparation; a document type 407, which may be selected from a predetermined list of document types, and which can be used to subsequently search for and locate documents of a certain type in a central file server, such as the central digital file server 105 shown in FIG. 1; a document expiration date 409, after which the document cannot be signed; a certificate requirement 411, which indicates the certification authority or authorities from which a user must have a digital certificate to be able to sign the document; a folder 413, identifying a folder, such as folder 307 shown in FIG. 3, in the central digital file server, such as central server 105 shown in FIG. 1, where the document should be stored; an indication of whether the document may be signed independently 415, to indicate whether a signing user may sign and submit the document without having other designated signatories sign as well; an indication of whether the document is to be treated as a transferable record 417, to indicate whether the signer should be required to consent to treat the document as a transferable record before he or she is permitted to sign; an indication of whether the document is secure 423, to indicate whether the document should be encrypted before it is transmitted to a signing user; user fields 419, 421 and 425, which allow entry of textual or other data to assist in subsequently searching for and locating a document in a central file server; and authorized signers 429, to indicate the party or parties who are permitted to sign the document.

User field 425 is accessed by clicking the associated icon, which presents a larger text entry box, not shown, for entering user data. The user data fields 419, 421 and 425 may further include computer readable data, such as data regarding a transaction associated with the digital document being prepared. For example, where the digital document being prepared is a contract of sale, user data stored in field 425 may include a code identifying the product sold, an indication of quantity sold, and an indication of the price of the goods sold. This data may be encoded in an XML data block. Numerous other types of user data and methods of encoding that data will be apparent to one of ordinary skill in the art. Once user fields 419, 421 and/or 425 are populated, the data may be embedded in the document and extracted subsequently by the central file server after the document has been signed and returned. Alternatively, or in addition to storing the user data in the document information block, the data may be stored in a central database in a record associated with the prepared document, as discussed in more detail herein.

The list of authorized signers 429, is populated by selecting the “Add Signer” button 427. In response, the user at the document preparation terminal may be presented with an interface window 500 as shown in FIG. 5. Interface window 500 prompts the user preparing the document to identify permitted signers. The user may indicate a wildcard by selecting checkbox 501. In this case, any user is permitted to sign the document, as indicated by entry 435 in FIG. 4. The user may instead select a previously registered user from drop down boxes 503 and/or 507. A user may be registered with a central server, such as central digital file server 105 in FIG. 1, to indicate his or her ability to use the central file server, including the document preparation application shown in FIGS. 3-5. Each user may be associated with a particular entity, such as his or her employer. In one embodiment, each entity has one ore more administrators responsible for registering new users associated with that entity. Each user may be given various permissions when they are registered. For example, some users may be permitted to prepare documents for signing, while other user may only be permitted to view documents. In selecting a permitted signer, the user of the document preparation terminal may select an entity name using drop down box 503. If the user preparing the document wanted to enable any authorized signer of the entity selected in box 503, he or she would select the “Authorized” check box 505. This would indicate than any user that is authorized to sign for the selected entity may sign the document, as indicated by entry 437 in FIG. 4. If the user preparing the document wanted to select a particular individual associated with the entity selected from drop down box 503, he or she could select the particular individual using drop down box 507. This would permit only the selected user to sign the document, as indicated by entry 439 in FIG. 4. Finally, if the user of the document preparation terminal wanted to give permission to an individual having a particular name who was not previously registered with the central server, the user may enter that person's name in boxes 509 and 511. An email address of the prospective signer may also be entered in box 513, in which case the document with the embedded information block or blocks will be emailed to the authorized signer once document preparation is finalized. As indicated in signer list 429 of FIG. 4, a user of the document preparation terminal may select one or more authorized signers of the document depending on the number of people or entities that are required to sign. Once the user has identified a party that is authorized to sign the document, he or she selects the “Ok” button 515 to return to the document preparation window 400. If the user wishes to cancel the operation of adding a permitted signer, he or she may select the “Cancel” button 517. The process of adding signers may continue by selecting the “Add Signer” button 427, until the user of the document preparation terminal has identified all users that are permitted to sign the document being prepared.

Once the user is satisfied that all information regarding the document to be signed is entered accurately, he or she may select the “Prepare” button 431, to initiate the embedding process. If the user is not satisfied that the information is entered accurately, he or she may select the “Cancel” button to return to the document selection window 300, shown in FIG. 3.

Upon selecting the “Prepare” button 431, the information to be embedded in the document is encoded in an information block or blocks, such as in XML format in the exemplary embodiment, and inserted into the digital document, such as by inserting the block or blocks into a hidden field of the document as previously described.

It will be apparent that the disclosed system for preparing documents could easily be modified to permit automatic document preparation. For example, the system could receive as input a database or spreadsheet listing new transactions for which documents were to be prepared for signing and the system could automatically prepare the documents in accordance with that input. Further, the system could prepare a document automatically in response to a request from a potential signing user. For example, the signing user could fill out a form on a website to begin a loan application, including in the form any relevant application data. The system could then convert the entered data into an electronic document and prepare the document with an embedded document information block based on the entered data and predetermined signing constraints.

In one exemplary embodiment of the present invention, the document information block or blocks is stored in a central database in addition to, or in lieu of, embedding the information block in the document. In one variant of this embodiment, certain information created at the document preparation terminal is stored in one or more records in a central database that is accessible by a central server. The one or more records include an identifier associated with the prepared document. Additionally, a document information block is embedded in the document to be signed, the document information block includes at least indicia of the identifier of the record or records in the central database that are associated with the prepared document. For example, the document information block may include a Document Tag ID, which is a unique identifier associated with the document that is created by the central server controlling the central database at the time the document is prepared for signing.

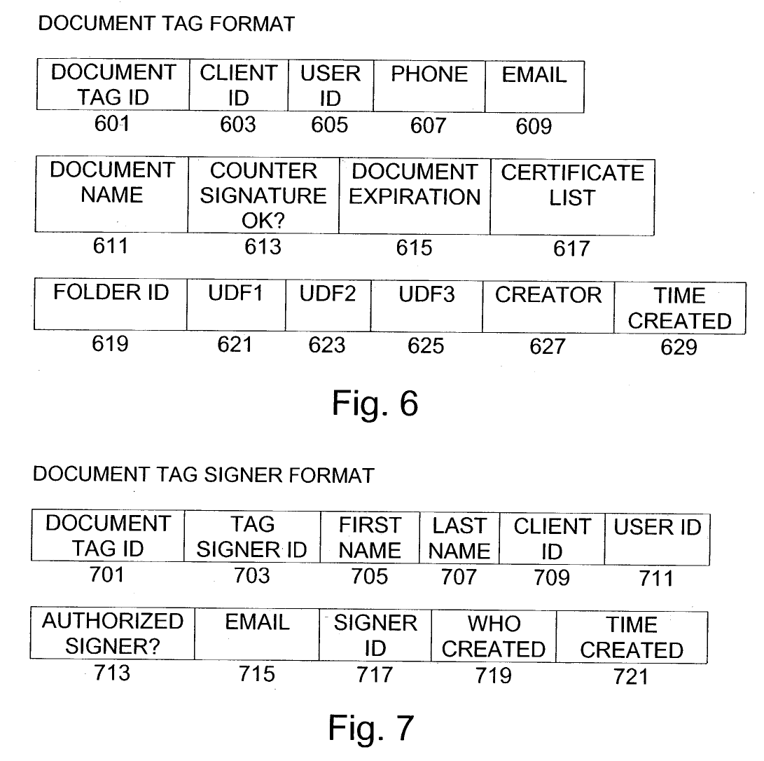

One exemplary data record format for the records stored in the central database is shown in FIG. 6. Each document would include at least one data record that includes the Document Tag ID 601 and each record may include data in the following fields: Client ID 603, User ID 605, Phone 607, Email 609, Document Name 611, Counter Signature OK flag 613, Document Expiration Date/time 615, Certificate List 617, Folder ID 619, three User Data Fields 621, 623, 625, Creator identification 627 and Time of Creation 629.

The Document Tag ID field 601 may represent the identifier created by the central server when the document is prepared for signing and is embedded in encoded form in the prepared document, as previously discussed.

The Client ID field 603 may indicate the employer or other organizational association of the person or entity preparing the document, or who “owns” the document. The concept of ownership will be discussed in further detail herein with respect to the operation of the system after the document is signed and returned to the central file server.

The User ID field 605 may indicate the person or subdivision of the entity identified in the Client ID field 603 that is preparing the document, or who “owns” the document.

The Phone and Email fields 607 and 609 indicate the telephone number and email address of the person or entity preparing the document or who “owns” the document. This information may be used by the signing terminal to present contact information to a signing user when the user has a question or comment about the document to be signed.

The Document Name field 611 indicates the name of the document to be displayed in the central file server interface 300, as shown in FIG. 3. This field may also indicate a file name of the document as stored on the central file server.

The Counter Signature OK field 613 indicates whether or not the document may be signed on multiple occasions. This would be of use where the document, such as a two party or multi-party contract, is prepared for signing by multiple signers. If the party preparing the document is willing to allow each party to sign separately, thus creating several signed “originals,” then this field may indicate that countersignatures are allowed. If instead, the party preparing the document required all signing parties to sign at one signing session, then this field may indicate that countersignatures are not allowed.

The Document Expiration field 615 is a date and/or time on or after which the document may not be signed.

The Certificate List field 617 may indicate a particular certificate authority, or may indicate a database record listing multiple certificate authorities that are trusted by the party preparing the document. This field could then be used during signing to identify a certificate or certificates held by the signing party that were issued by a trusted certificate authority. If the signing party does not have a certificate from a trusted certificate authority, he or she may be refused permission to sign the document.

The Folder ID field 619 is used to indicate a folder in the central file server where the document should be listed after it is signed and received back at the central file server. The use of folders to organize documents is explained in further detail herein.

The UDF1, UDF2 and UDF3 fields may indicate user defined data such as transaction data related to the document or other information.

The Creator field 627 may identify the party that prepared the document for signing. This field may be the same as the User ID field 605, as previously discussed.

The Time Created field 629 may identify the date and/or time when the document was prepared for tagging.

The central database may also include records identifying permitted signers of the prepared documents. One exemplary data record format for these such records is shown in FIG. 7. In the exemplary embodiment, for each prepared document, a separate record is created for each authorized signer. Each such data record includes a Document Tag ID field 701 and may include data in the following fields: Tag Signer ID 703, First Name 705, Last Name 707, Client ID 709, User ID 711, Authorized Signer indicator 713, Email 715, Signer ID 717, Who Created 719 and Time Created 721.

As previously discussed, Document Tag ID 701 represents a system created identifier for the document prepared to be signed. The Tag Signer ID field 703 includes an identifier associated with the particular signer to which the data record corresponds. For example, the record may correspond to the second user identified as a permissible signer of the prepared document, in which case the Tag Signer ID may be the number 2.

The First Name and Last Name fields, 705 and 707 may be used to indicate the first and last name of an authorized signer.

The Client ID field 709 may be used to indicate the employer or entity associated with the authorized signer. This field may be used in conjunction with the authorized signer field indicator 713 to indicate that any authorized signer of the entity identified in field 709 may sign the document.

The User ID field 711 may indicate the User ID of the person or entity that is authorized to sign the document. This field would be of use where the authorized signer has previously been registered with the central file server.

The Email field 715 may indicate the email address of the authorized signer. This field could be used by the central file server to automatically transmit the document to the user for signing upon completion of the preparation process.

The Signer ID field 717 may be left empty when the document is prepared. Upon receiving the signed document from the signing user, the field may be populated with the User ID of the user that signed the document. In other words, during the signing process, the signing user is prompted to register with the central file server if he or she has not already done so, to establish a User ID. That User ID would thereafter be used by that user to identify himself or herself to the central file server in subsequent signing operations and may be stored in field 717 once the signed document is received.

The Who Created field 719 may be similar to field 627 shown in FIG. 6 in that the field may indicate the user that prepared the document for signing.

The Time Created field 721 may be similar to field 629 shown in FIG. 6 in that the field may indicate the date and/or time that the document was prepared for signing.

Once the document has been prepared, it is transmitted 209 to a signing terminal 203, as illustrated in FIG. 2. In the exemplary embodiment, the document, or instructions on how to access and view the document may be automatically sent via email by the document preparation terminal 201 to the user or users identified as permitted signers. Alternatively, a user of the document preparation terminal 201 may manually email or otherwise transmit the document, or instructions on accessing and viewing the document to the user or users permitted to sign the document.

Upon receiving the document, a user at signing terminal 203 may view the document to be signed. Software used to view the prepared document may be, in the exemplary embodiment, ACROBAT READER from ADOBE SYSTEMS, INC. together with a plug-in signing software code segment. The plug-in software enhances the functionality of ACROBAT READER to implement the operations of the present invention. The communication that includes the document to be signed or instructions on retrieving the document to be signed may also inform the potential signer how to retrieve and install the signing software necessary to complete the signing process. Rather than being a plug-in to the document viewing software, the signing software code segment may be provided over a webpage as a web service, in a similar fashion to the document preparation application previously described. Additionally, where the distribution of the document is particularly sensitive, the signing terminal may make use of a secure computing environment, as previously described. In that scenario, the signing software may run partially or entirely within the secure computing environment. When such security is required, the document itself will typically be encrypted before it is transmitted by the document preparation terminal and the secure computing environment is used to prevent the decrypted document data from entering the unsecured computing environment.

Upon viewing the prepared document, the user may indicate a desire to sign the document by making a signing request 211, using well-known techniques. For example, the user may actuate an icon in the document viewing software associated with the document signing software using a computer mouse. The signing terminal then invokes the signing software, which first extracts and decodes any document information block or blocks embedded in the document.

In one exemplary embodiment, the signing software may display and icon and/or other indicia associated with the entity that prepared the document. The icon and indicia may be downloaded from the central file server using information extracted from a document information block. In this fashion, multiple document preparation entities could distribute or otherwise make available identical signing software, while still promoting brand awareness and provide further assurances of trust to signing users.

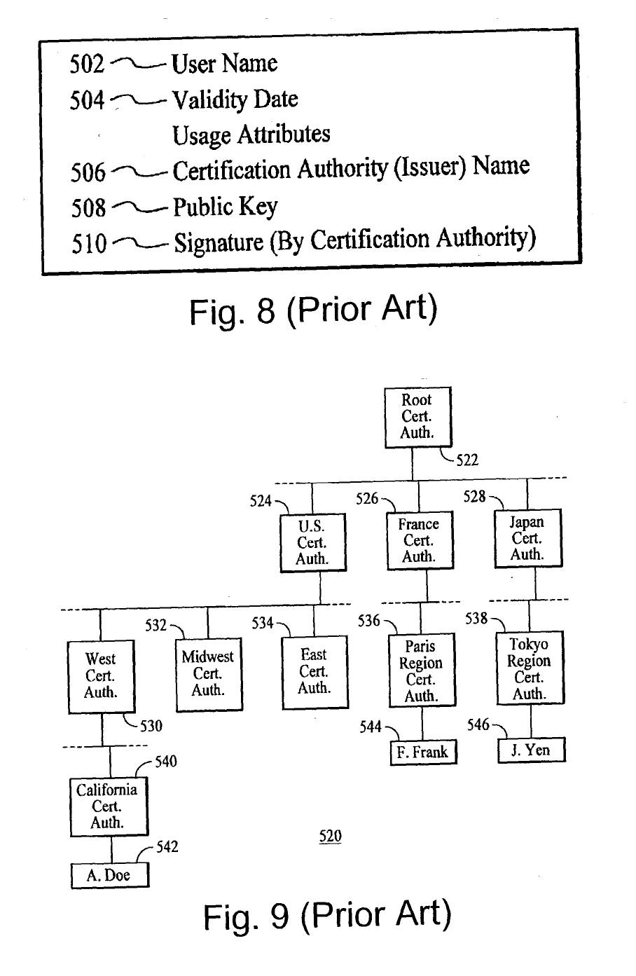

In the exemplary embodiment where the document information blocks provide indicia of the signing constraints that must be satisfied before the document may be signed, the process proceeds to step 213 and the signing terminal 203 determines whether the user may sign the document. The details of step 213 will vary depending on the signing constraint that is associated with the document information block. For example, where the information block includes indicia of a signing constraint requiring the signing party to have a particular digital certificate, such as a certificate issued by a certain certification authority, or a certificate having a certain security or authorization level, as previously discussed, then the signing terminal 203 may examine any digital certificates accessible by the signing terminal, such as certificates previously stored within the signing terminal or embedded in a secure media, such as a smart cards accessible by the signing terminal. If the signing terminal 203 determines that one accessible digital certificate satisfies the signing constraint, then the signing terminal will permit the user at the terminal 203 to proceed to sign the document 217 using the certificate that satisfied the constraint. If the signing terminal 203 locates more than one digital certificate that satisfies the signing constraint, the user may be presented with a list of located certificates that satisfy the signing constraint. The user may then select a certificate from the list with which to sign the document during step 217. If an acceptable digital certificate is not found, the process terminates 215. Further, the signing terminal 203 may check the digital certificate associated with the key that is to be used to sign the document for its validity. This may entail determining whether the certificate has expired, as specified by a validity date 504 appearing on the certificate, as shown in FIG. 8. Further, the signing terminal software may query the central authority to determine if the certificate is listed as revoked. Additionally, the signing terminal software may verify that the signature, such as signature 510 shown in FIG. 8, appearing on the certificate is valid and is the signature of a trusted certification authority and/or is the signature of a certification authority that itself has been certified by a trusted certification authority. This process may be effectuated using a certification tree, as depicted in FIG. 9, previously discussed. Alternatively, the signing terminal software may perform only some of these validity functions and further, or duplicative, validity checks may be performed by the central file server.

Another exemplary document information block may include an expiration date, after which the document may not be signed. In this example, the signing terminal may determine the current time either from an internal trusted clock, such as a clock operating within a secure computing environment accessible by the signing terminal 203, or the signing terminal may request the current time from another computer 221, such as the central file server 205, over a computer network. Throughout this application, a request from the signing terminal 203 to a central server for information to be used in determining whether a signing constraint is satisfied will be referred to as a server information block. In one variant of this embodiment, a document information block embedded in the document may include the name and/or address of a central server from which the signing terminal 203 should request the current time. For example, a Uniform Resource Locator (URL) identifying the address of a central file server on a computer network, such as the Internet, may be included in the document information block. Additionally, a User ID and password may be encoded in encrypted form in the document information block embedded in the document. This User ID and password may be used by the software on the signing terminal 203 to authenticate itself with the central digital file server 205 during or before the lookup request 221. In any event, in response to the lookup request 221, a responsive server information block 223 that includes indicia of the current date and/or time is transmitted to the signing terminal for comparison against the expiration date of the document. If the document has not expired, the user at the signing terminal 203 is permitted to sign 217. If the document has expired, the process terminates 215.

A further exemplary document information block may indicate that the signing party must consent to the use of electronic documents to evidence any transaction related to the document and/or consent to treat the electronic document as a transferable record under the E-SIGN law. In that case, the signing terminal 203 would prompt the user to consent to treat the document as a transferable record, as indicated by, for example, electronically signing a consent form or actuating an icon or button on a user interface. If the user consents, the process may proceed to permit the user to sign the document 217. If the user refuses to consent to the use of electronic documents, the process may terminate 215.

Another exemplary document information block may include a particular software type or minimum software version required to sign the document. The signing terminal 203 would compare the received software type or version to the current type and/or version of the signing software running on the signing terminal. In an alternative embodiment, the signing terminal 203 may make a request 221 of the central digital file server 205 to report the current software type and/or version necessary to sign documents. The central digital file server 205 would then respond 223 with a server information block identifying the currently required software type and/or version. The location of the central digital file server 205 may be determined from a URL encoded in a document information block embedded in the document, as previously described. If the software is the correct type and/or is as recent or more recent than the required software version, the process may proceed to allow the user to sign the document 217. If the currently running software version is an incorrect type and/or is older than the necessary version, the process may terminate 215. In the case where the proper software is not running on the signing terminal 203, the user may be provided instructions as to how to retrieve and install the correct software. Alternatively, rather than terminating 215, the correct software may automatically be retrieved and installed if the current version is insufficient as indicated by the document information block, and the process would then proceed to allow the user at the signing terminal 203 to sign the document 217 using the newly retrieved software.

In yet a further exemplary embodiment of the document information block, the block may include an indication of a user or users who are allowed to sign the document. For example, as previously described, the information block may indicate that any user may sign the document. Accordingly, any user would be permitted to sign 217. Alternatively, the information block may identify a particular user or a particular class of users that may sign. For example, the information block may include the name of an authorized signer. The signing terminal 203 would then determine if the name of the user at the signing terminal is the same as the name in the information block. If the user is a permitted signer, the process proceeds and the user is allowed to sign the document 217. If the user is not identified as a permitted signer or is not a member of a class of permitted signers as indicated in the document information block, the process terminates 215.

In the exemplary embodiment where the document information is stored in a central database, the process of determining whether the user at the signing terminal 203 is permitted to sign the document may be preformed by the central digital file server 205 or indicia of any relevant signing constraint may be transmitted 223 to the signing terminal 203 from the central server 205 so the signing terminal can make the necessary determination. In either case, some information is first extracted from the document and transmitted 221 to the central digital file server 205 as previously described. The transmitted information might include an identification of the user at the signing terminal and/or an identification of the document to be signed, such as by transmitting a Document Tag ID extracted from a document information block embedded in the document. The identification of the user at the signing terminal 203 may be determined by prompting the user at the signing terminal to first enter a user identification block, such as a User ID, full name and/or the location of a digital certificate. The central file server 205 then locates the relevant database record or record corresponding to the Document Tag ID and either transmits 223 any associated signing criteria indicia to the signing terminal 203, or the server may determine, from the information received from the signing terminal 203 and the database records, whether the user at the signing terminal is permitted to sign the document. In this case, the server transmits a response 223 to the signing terminal 203 indicating either that the user is permitted to sign the document, or indicating that the user is not permitted to sign. If the user is permitted to sign, as determined either by the signing terminal 203 based on information received from the central file server 205 or as determined by the central file server itself, the process proceeds and the user is permitted to sign 217. If the user is not permitted to sign, the process terminates 215.

The system may require signing users to register with the central file server 205 before signing a document. In that case, the user is prompted to create a User ID and password and to associate at least one digital certificate with his or her account. Thereafter, that User ID and password will be used by the user to identify himself or herself to the central filer server 205. Additionally, the central file server 205 may thereafter prohibit any person from associating the previously associated digital certificate with another User ID. This would prohibit a party in possession of a user's digital certificate and associated private key but not the user's password from simply registering the digital certificate with the central file server a second time using a User ID for which the party did know the associate password.

Further, the User ID and password associated with a signer could be subsequently used to log on to the central file server for the limited purpose of viewing documents that have been signed by that user. In this fashion, the central file server could serve as a virtual safe deposit box, holding important documents that have bee signed by that user.

If it is determined that the user at the signing terminal 203 is permitted to sign the document, such as after determining whether any necessary signing criteria are met, the document is digitally signed 217 using a private signature key associated with the user using techniques well known to one of ordinary skill in the art, as previously described. In one exemplary embodiment, the document, document information block, electronic signature block (i.e. the encrypted hash), and the original document are combined into a single digital file and transmitted 219 over a computer network, such as the Internet, to the central file server 205. The signed file may further include the signing software version used to sign the document, a time/date stamp retrieved from a trusted time server as the time of signing, as well as the User ID of the user that signed the document. In one exemplary embodiment, the trusted time server is the central file server 205 itself. The user at the signing terminal 203 may be prompted to actuate the transmission of the combined document data, such as by clicking a “submit” button, not shown, or by other well-known devices. If the contents of the document or information regarding the transaction is confidential, the contents of the combined file may be encrypted using a public key associated with the central file server 205 or the entity that prepared the document. The public key may be included in the document information block when it is originally prepared to assist in accomplishing this step. Upon receipt, the central file server 205 stores the document on a recording medium, such as a hard disk drive or an array of hard disk drives. The central file server 205 may also generate a notification via email or other means to notify the signer that a signed document has been received. This would ensure that no one is able to fraudulently sign a document using a particular person's private key without alerting that person that their key had been used. Further, the file server 205 may generate a notification to the person or entity that prepared the document when the signed document is received. In one exemplary embodiment, each entity selects its notification preferences that apply to all document prepared by persons associated with it. Alternatively, notification preferences could be embedded in a document information block or in a database record associated with each document identified by a document information block.

In one exemplary embodiment where a document information block provides indicia of a signing constraint that requires multiple parties to sign the document in one signing session, the signing terminal 203 will not permit the document to be transmitted until all users have signed the document at the signing terminal.

In another exemplary embodiment, the central vault 205 confirms the received document is authentic before it is stored. This process may include verifying the signature or signatures, such as by decrypting the message hash using the public key of the signing user and comparing the decrypted hash with a hash of the document computed by the central vault 205. The vault 205 may also access a certificate revocation list of the certification authority that issued the digital certificate of the signing party. If the certificate used to sign the document has not been revoked by the certification authority, the document may be accepted for storage. Alternatively, the document may always be stored at the central filer server and an indication may be made in a database record associated with the document to indicate that the document was signed with a revoked certificate. Additionally, the vault 205 may confirm the digital certificate used to sign the document has a valid certificate chain or is otherwise signed by a trusted certification authority.

In one embodiment, upon receipt of the signed document, the central file server 205 may optionally update the central database records associated with the received document. Such records were optionally created during the document preparation process as previously described. In this embodiment, the record updating includes modifying the record to indicate that the document has been signed. Further, a copy of the signed document may be made accessible to certain persons logging in to the central file server 205. This could be accomplished by adding a link representing the signed document, such as the link 323 shown in FIG. 3, in a folder, such as folder 307, accessible by a user logged on to the central file server website as previously described. As shown, both signed and unsigned documents appear in file list 311 within the selected folder 307. The status of each document as signed or unsigned is indicated by information appearing in column 321, where a “Yes” entry indicates the document has been signed and a blank entry indicates the document has not yet been signed.

The folder where the link representing the signed file is displayed may be specified during document preparation, such as by entering a folder name in text box 413 shown in FIG. 4, during document preparation, as previously described. This information may be stored in the central database in a record associated with the document and/or the information may be inserted in a document information block during preparation and the folder name subsequently extracted and decoded by the central file server 205 upon receipt of the signed document. Each user that is registered with the central file server 205 may be given access to certain folders and restricted from accessing certain folders. In this manner, the person preparing the document may determine who may view the signed document upon its receipt at the central file server 205 by selecting a specific folder in which the link that represents the signed file is to appear.

In the case where a folder name is not specified during preparation, or where the specified folder does not exist at the time the document is received for storage, the central file server 205 could store the document in a default folder associated with the person or entity who created the document, as determined from a database record or document information block.

In one exemplary embodiment, a copy of the signed document may be viewed by actuating a user input device, such as a computer mouse, and clicking on the link representing the signed document. In response, the central file server 205 accesses the combined signed document file, extracts the unsigned digital document that is a part of the combined signed document, adds a watermark to the unsigned document, such as an indication appearing on the document that the document is an electronic copy, and displays the watermarked document to a user of the central file server 205. In the exemplary embodiment, the watermark may be added by well known software such as ACTIVE PDF, previously discussed. Further, signing data may be appended to the document for visually indicating that the document has been signed. This data may be extracted from the central database records associated with the document and may include an identification of the individual or individuals that digitally signed the document and the time the document was signed by that individual or individuals. This signing data may also be appended using the ACTIVE PDF or similar well-known software. In this fashion, the original signed document, in the form of the combined digital data file that is received by the central file server 205, is not directly viewable by a user. Further, the system prevents a user from altering the originally signed file. Finally, the system ensures that any copy of the signed document is identified as a copy, enabling the document to meet the requirements of a transferable record under the E-SIGN law, which requires any system used to evidence the possession or transfer of a transferable record maintain only one “authoritative copy” of the transferable record and ensure that any copies of the authoritative copy are “readily identifiable as a copy that is not the authoritative copy.” 15 U.S.C. §7021 (c)(5).

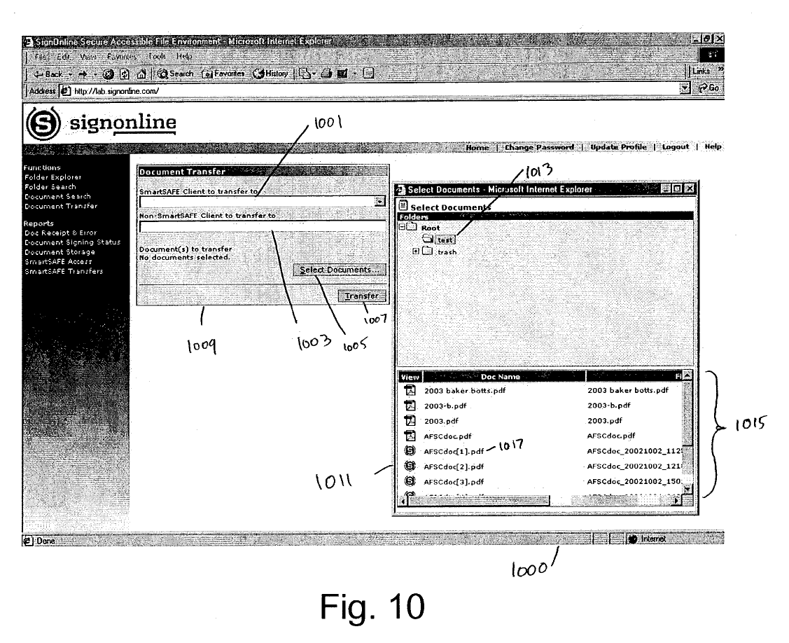

To further enable the use of the system to store and manage transferable records, each received document is associated with a single “owner” in the central database records. The document owner may be established during document preparation, such as by defaulting ownership to the user or entity preparing the document. This information may be stored in the central database in a record associated with the prepared document and/or the information may be encoded into the document information block or blocks that is embedded into the document during document preparation. Subsequently, the ownership of a document, such as a document that is to be treated as a transferable record, may be transferred. In that case, the system will only allow the current owner of the record to transfer the document. The owner of a document may accomplish a transfer of a document to another user of the central file server 205 by selecting the Document Transfer function hyperlink 325 of the central filer server software, shown in FIG. 3. By actuating the Document Transfer hyperlink 325, in an exemplary embodiment, the user is presented with a window, such as window 1000 shown in FIG. 10. Window 1000 includes data entry area 1009. The data entry area 1009 allows the owner of a document to select a document to transfer by actuating the “Select Documents” button 1005. Upon actuating the Select Documents button 1005, a second window 1011 is presented to the user. The user may then select a folder, such as folder 1013. Upon selecting a particular folder, a list of documents in the selected folder is generated and displayed in frame 1015. The user may then select a document or documents for transfer by selecting a displayed document record, such as record 1017. Upon selecting the document or documents for transfer, the user may then select a particular user or entity to transfer the document to, using drop down box 1001. If the entity that is to receive the document is not registered with the central file server 205, the entity may be otherwise identified in field 1003. Once an entity has been identified to receive the document, the “Transfer” button 1007 may be selected and the ownership of the document may thereby be transferred. Thereafter, the original owner of the document would be unable to further transfer the document as only the new owner will be permitted that functionality. The document may also be transferred to the signer of the document or to a paid off category. This would be useful, for example, where the document is a promissory note representing an obligation on behalf of the signer to repay the entity preparing the document, such as a bank. Upon full repayment, the signed promissory note may be transferred back to the signer or to a paid off category to indicate that the note has been repaid.

Users with access to signed documents in the central file server 205, such as through interface window 300 shown in FIG. 3 may also be able to utilize data encoded in the document information block or blocks embedded within the document. For example, a user could extract transactional data related to the document that is stored in user fields such as UDF1 621, UDF2, 623 and UDF3 625. This information may be used in backend computer systems such as inventory management, accounting and billing systems and the like.

The system of the present invention also allows users with access to signed documents to query the central file server 205 for other information relating to documents. For example, a user may be request a list of all documents prepared by that user or by the entity with which that user is associated that have been prepared but not yet signed. Numerous other such queries will be apparent to one of ordinary skill in the art.

The foregoing merely illustrates the principles of the invention in exemplary embodiments. Various modifications and alterations to the described embodiments will be apparent to those skilled in the art in view of the teachings herein. For example, while numerous particular signing constraints have been set forth herein, it will be apparent that many other signing constraints might be advantageous and the present system could easily be programmed to accommodate those constraints. Further, while the present invention has generally been discussed with respect to financial and commercial documents, it will be apparent to one of ordinary skill that the system is not limited to such documents and can be utilized to manage any document capable of being electronically signed and stored. Further, although specific system components and software have been described by way of exemplary embodiments, it will be understood that no limitation is intended thereby. It will thus be fully appreciated that those skilled in the art will be able to devise numerous systems and methods which, although not explicitly shown or described, embody the principles of the invention and thus are within the spirit and scope of the invention as defined in the appended claims.

We claim:

1. A method for electronically signing a digital data file, comprising:
a) embedding in a first digital data file, at a document preparation terminal, at least one information block associated with at least one signing constraint, to form a second digital data file;
b) transmitting over a first computer network said second digital data file to a document signing terminal;
c) receiving by said document signing terminal a request from a user of said document signing terminal to electronically sign said second digital data file, said user of said document signing terminal having at least one associated digital private key;
d) determining, at said document signing computer, whether said at least one signing constraint is satisfied;
e) electronically signing said second digital data file using at least said digital private key associated with said user of said document signing terminal if the result of said step d) is that said at least one signing constraint is satisfied, thereby forming a third digital data file; and
f) transmitting said third digital data file over a second computer network from said signing terminal to a central digital file server for storage.

2. The method of claim 1, wherein said at least one signing constraint relates to an expiration date before which said second digital data file must be signed, further comprising:
g) determining, before said step d), the current date;
wherein said determining step d) comprises determining that said at least one signing constraint is satisfied if the result of said step g) is that said current date is earlier than the expiration date before which said second digital data file must be signed.

3. The method of claim 1, wherein said digital private key is associated with a digital certificate issued by a certification authority that issues digital certificates having a particular one of at least two authorization levels, and wherein said signing constraint relates to a minimum authorization level of said digital certificate, further comprising:
g) determining, before said step d), the authorization level of the digital certificate associated with said digital private key;
wherein said determining step d) comprises determining that said at least one signing constraint is satisfied if the result of said step g) is that said authorization level of the digital certificate associated with said digital private key is equal to or exceeds said minimum authorization level.

4. The method of claim 1, wherein said digital private key is associated with a digital certificate issued by a certification authority, and wherein said signing constraint relates to a list of at least one trusted certification authority, further comprising:
g) determining, before said step d), whether said digital certificate is issued by a certification authority that is in said list of at least one trusted certification authority;
wherein said determining step d) comprises determining that said at least one signing constraint is satisfied if the result of said step g) is that said digital certificate is issued by a certification authority that is in said list of at least one trusted certification authority.

5. The method of claim 1, wherein said signing constraint relates to said user of said document signing terminal consenting to treat said third digital data file as a transferable record, further comprising:
g) prompting, before said step d), said user of said document signing terminal to consent to treat said third digital data file as a transferable record,
wherein said determining step d) comprises determining that said at least one signing constraint is satisfied if said user of said document signing terminal indicated consent to treat said third digital data file as a transferable record during said step g).

6. The method of claim 1, wherein said signing constraint relates to the identity of a specific user having permission to sign said second digital data file, further comprising:
g) prompting, before said step d), said user of said document signing terminal to provide an indicia of identity,
wherein said determining step d) comprises determining that said at least one signing constraint is satisfied if said user of said document signing terminal is the specific user having permission to sign said second digital data file.

7. The method of claim 1, wherein said signing constraint relates to the identity of a class of users having permission to sign said second digital data file, further comprising:
g) prompting, before said step d), said user of said document signing terminal to provide an indicia of identity,
wherein said determining step d) comprises determining that said at least one signing constraint is satisfied if said user of said document signing terminal is a member of the class of users having permission to sign said second digital data file.

8. The method of claim 1, further comprising:
g) receiving, before said step d), from a central server, a server information block;
wherein information in said server information block is used during said step d) to determine whether said at least one signing constraint is satisfied.

9. The method of claim 1, wherein said step a) further includes embedding in said first digital data file a second information block having indicia of transactional data related to said first digital data file, further comprising:
g) extracting, after said step f), from said third digital data file, said second information block; and
h) recording in an transactional data field in a database record indicia of said transactional data related to said first digital data file.

10. The method of claim 1, wherein said step a) further includes embedding in said first digital data file a second information block having an indicia of an owner of said third digital data file, further comprising:
g) extracting, after said step f), from said third digital data file, said second information block;
h) recording in an owner data field in a database record, the owner of said third digital data file based on said extracted second information block; and
i) modifying, after said step h), said owner data field to transfer the ownership of said third digital data file.

11. The method of claim 1, wherein said first and second computer networks are both part of a single computer network.

12. The method of claim 8, wherein said central server and said central digital file server are both part of a single computer server.

13. A system for electronically signing a digital data file, comprising:
a first computer readable storage area containing a first computer code segment, said first computer code segment for actuating a processor of a document preparation terminal, said first computer code segment providing functionality for accessing a first digital data file and for embedding at least one information block associated with at least one signing constraint into said first digital data file to form a second digital data file;
an electronic document file storage device having a network interface for receiving digital data files and a digital storage medium for storing said digital data files received by said network interface device;
a second computer readable storage area containing a second computer code segment, said second computer code segment for actuating a processor of a document signing terminal, said second computer code segment providing functionality for: (a) receiving a request from a user of said document signing terminal to electronically sign said second digital data file, (b) determining whether said user of said document signing terminal is permitted to sign said second digital data file based on at least said at least one signing constraint associated with said at least one information block, (c) electronically signing said second digital data file using at least one digital private key associated with said user of said document signing terminal if the result of said determining is that said at least one signing constraint is satisfied, said electronically signing resulting in a third digital data file, and (d) transmitting said third digital data file to said electronic document file storage device.

14. A method for electronically signing a digital data file, comprising:
a) embedding in a first digital data file, at a document preparation terminal, at least one information block identifying a database record in a central database, to form a second digital data file;
b) transmitting over a first computer network said second digital data file to a document signing terminal;
c) receiving by said document signing terminal, a request from a user of said document signing terminal to electronically sign said second digital data file, said user of said document signing terminal having at least one associated digital private key;
d) receiving by said central database, a record lookup request from said document signing terminal, the contents of said lookup request based on said at least one information block;
e) transmitting to said document signing terminal over a second computer network indicia associated with at least one signing constraint in response to said lookup request;
f) determining, at said document signing computer, whether said at least one signing constraint is satisfied;
g) electronically signing at said document signing terminal, said second digital data file using at least said at least one digital private key associated with said user of said document signing terminal if the result of said step f) is that said at least one signing constraint is satisfied, thereby forming a third digital data file; and
h) transmitting said third digital data file over a third computer network from said signing terminal to a central digital file server for storage.

15. The method of claim 14, wherein said at least one signing constraint relates to an expiration date before which said second digital data file must be signed, further comprising:
i) determining, before said step f), the current date;
wherein said determining step f) comprises determining that said at least one signing constraint is satisfied if the result of said step i) is that said current date is earlier than the expiration date before which said second digital data file must be signed.

16. The method of claim 14, wherein said digital private key is associated with a digital certificate issued by a certification authority that issues digital certificates having a particular one of at least two authorization levels, and wherein said signing constraint relates to a minimum authorization level of said digital certificate, further comprising:
i) determining, before said step f), the authorization level of the digital certificate associated with said digital private key;
wherein said determining step f) comprises determining that said at least one signing constraint is satisfied if the result of said step i) is that said authorization level of the digital certificate associated with said digital private key is equal to or exceeds said minimum authorization level.

17. The method of claim 14, wherein said digital private key is associated with a digital certificate issued by a certification authority, and wherein said signing constraint relates to a list of at least one trusted certification authority, further comprising:
i) determining, before said step f), whether said digital certificate is issued by a certification authority that is in said list of at least one trusted certification authority;
wherein said determining step f) comprises determining that said at least one signing constraint is satisfied if the result of said step i) is that said digital certificate is issued by a certification authority that is in said list of at least one trusted certification authority.

18. The method of claim 14, wherein said signing constraint relates to said user of said document signing terminal consenting to treat said third digital data file as a transferable record, further comprising:
i) prompting, before said step f), said user of said document signing terminal to consent to treat said third digital data file as a transferable record,
wherein said determining step f) comprises determining that said at least one signing constraint is satisfied if said user of said document signing terminal indicated consent to treat said third digital data file as a transferable record during said step i).

19. The method of claim 14, wherein said signing constraint relates to the identity of a specific user having permission to sign said second digital data file, further comprising:
i) prompting, before said step f), said user of said document signing terminal to provide an indicia of identity,
wherein said determining step f) comprises determining that said at least one signing constraint is satisfied if said user of said document signing terminal is the specific user having permission to sign said second digital data file.

20. The method of claim 14, wherein said signing constraint relates to the identity of a class of users having permission to sign said second digital data file, further comprising:
i) prompting, before said step f), said user of said document signing terminal to provide an indicia of identity,
wherein said determining step f) comprises determining that said at least one signing constraint is satisfied if said user of said document signing terminal is a member of the class of users having permission to sign said second digital data file.

21. The method of claim 14, further comprising:
i) receiving, before said step f), from a central server, a server information block;
wherein said server information block is used during said step f) to determine whether said at least one signing constraint is satisfied.

22. The method of claim 14, wherein said database record is associated with said first digital data file and includes at least a first data field storing indicia of at least one signing constraint and second data field storing indicia of transactional data related to said first digital data file.

23. The method of claim 14, wherein said database record is associated with said first digital data file and includes at least a first data field storing indicia of at least one signing constraint and second data field storing indicia of an owner of said third digital data file, further comprising:
i) modifying, after said step h), said owner data field to transfer the ownership of said third digital data file.

24. The method of claim 14, wherein said first, second and third computer networks are all part of a single computer network.

25. The method of claim 21, wherein said central server and said central digital file server are both part of a single computer server.

26. A system for electronically signing a digital data file, comprising:
a central database;
a first computer readable storage area containing a first computer code segment, said first computer code segment for actuating a processor of a document preparation terminal, said first computer code segment providing functionality for accessing a first digital data file and for embedding at least one information block identifying a database record in said central database, into said first digital data file to form a second digital data file;
an electronic document file storage device having a network interface for receiving digital data files and a digital storage medium for storing said digital data files received by said network interface device;
a second computer readable storage area containing a second computer code segment, said second computer code segment for actuating a processor of a document signing terminal, said second computer code segment providing functionality for: (a) receiving a request from a user of said document signing terminal to electronically sign said second digital data file, (b) transmitting to said central database a record lookup request, the contents of said lookup request based on said at least one information block, (c) receiving from said central database, indicia associated with at least one signing constraint in response to said record lookup request, (d) determining whether said user of said document signing terminal is permitted to sign said second digital data file based on at least said at least one signing constraint, (e) electronically signing said second digital data file using at least one digital private key associated with said user of said document signing terminal if the result of said determining is that said at least one signing constraint is satisfied, said electronically signing resulting in a third digital data file, and (f) transmitting said third digital data file to said electronic document file storage device.

27. A method for electronically signing a digital data file, comprising:
a) embedding in a first digital data file, at a document preparation terminal, at least one document information block identifying at least one database record in a central database accessible by a central server, to form a second digital data file;
b) transmitting over a first computer network said second digital data file to a document signing terminal;
c) receiving by said document signing terminal, a request from a user of said document signing terminal to electronically sign said second digital data file, said request including a user identification information block identifying said user, said user of said document signing terminal having at least one associated digital private key;
d) receiving by said central server, a signing permission request from said document signing terminal, the contents of said signing permission request based on said at least one document information block and said user identification information block;
e) accessing, by said central server, said at least one database record in said central database identified by said document information block to retrieve indicia of at least one signing constraint;
f) determining, at said central server, whether said user of said document signing terminal is permitted to sign said second digital data file based on at least said user identification information block and said indicia of at least one signing constraint;
g) receiving at said document signing terminal from said central server a positive signing permission response if the result of said step f) is that said signing constraint is satisfied and receiving at said document signing terminal a negative signing permission response if the result of said step f) is that said signing constraint is not satisfied;
h) electronically signing at said document signing terminal, said second digital data file using at least said at least one digital private key associated with said user of said document signing terminal if a positive signing permission response was received in step g), thereby forming a third digital data file; and
i) transmitting said third digital data file over a second computer network from said signing terminal to a central digital file server for storage.

28. The method of claim 27, wherein said first and second computer networks are both part of a single computer network.

29. The method of claim 27, wherein said central server and said central digital file server are both part of a single server.

30. A system for electronically signing a digital data file, comprising:
a central database;
a central server coupled to and capable of accessing data records stored in said central database;
a first computer readable storage area containing a first computer code segment, said first computer code segment for actuating a processor of a document preparation terminal, said first computer code segment providing functionality for accessing a first digital data file and for embedding at least one document information block identifying at least one database record in said central database, into said first digital data file to form a second digital data file;
an electronic document file storage device having a network interface for receiving digital data files and a digital storage medium for storing said digital data files received by said network interface device;
a second computer readable storage area containing a second computer code segment, said second computer code segment for actuating a processor of a document signing terminal, said second computer code segment providing functionality for: (a) receiving a request from a user of said document signing terminal to electronically sign said second digital data file, said request including a user identification information block identifying said user, (b) transmitting to said central server a signing permission request, the contents of said signing permission request based on said at least one document information block and said user identification information block, (c) receiving, from said central server, a response to said signing permission request, (d) electronically signing said second digital data file using at least one digital private key associated with said user of said document signing terminal if said response to said signing permission request indicates that said user is permitted to sign said second digital data file, and (f) transmitting said third digital data file to said electronic document file storage device;
wherein said central server has further functionality for receiving said signing permission request from said document signing terminal, accessing said at least one database record in said central database identified by said document information block to retrieve indicia of at least one signing constraint, determining whether said user of said document signing terminal is permitted to sign said second digital file based on at least said user identification information block and said indicia of at least one signing constraint, and transmitting a response indicating that said user is permitted to sign said second digital data file if the result of said determining is that said signing constraint is satisfied and transmitting a response indicating that said user is not permitted to sign said second digital data file if the result of said determining is that said signing constraint is not satisfied.

31. A method for electronically managing a digital data file, comprising:
a) embedding in a first digital data file, at a document preparation terminal, at least one document information block identifying at least one database record associated with said first digital data file in a central database, to form a second digital data file;
b) transmitting over a computer network said second digital data file to a document signing terminal;
c) electronically signing, at a document signing terminal, said second digital data file using at least one digital private key associated with at least one user of said document signing terminal, thereby forming a third digital data file;
d) receiving over said computer network at a central digital file server, said third digital data file from said signing terminal;
e) extracting, after said step d), said at least one document information block from said third digital data file; and
f) updating, after said step e), said at least one database record identified by said document information block.

32. The method of claim 31, wherein said step f) includes updating said at least one database record to include a date/time stamp indicating the time when said third digital data file was received at said central digital file server.

33. The method of claim 31, wherein said step f) includes updating said at least one database record to include identification information related to said at least one user of said signing terminal associated with said at least one digital private key used during said step c).

34. The method of claim 31, wherein said step f) includes updating said at least one database record to indicate a current owner of said third digital data file.
